(19) United States
(12) Patent Application Publication
(10) Pub. No.: US 2008/0116278 A1
(43) Pub. Date: May 22, 2008

(54) System and Method for Providing Data to a Wireless Device

(76) Inventor: Alan J. Epshteyn, Miller Place, NY (US)

Correspondence Address: FAY KAPLUN & MARCIN, LLP, 150 BROADWAY, SUITE 702, NEW YORK, NY, 10038, US

(21) Appl. No.: 11/562,013

(22) Filed: Nov. 21, 2006

(51) Int. Cl. G06K 7/10

(52) U.S. Cl. 235/462.25

(57) ABSTRACT

A device having a data capture arrangement to capture data included in a data identifier, the data identifier being separate from the device and a processor to receive the data and perform an operation, the processor using at least a portion of the data to perform the operation. A method for capturing data from a data identifier and performing an operation, the operation using at least a portion of the captured data.

### BACKGROUND

Users utilize mobile devices to accomplish a wide variety of tasks. Those tasks may include phone dialing, sending emails, or accessing web pages. Additional functionality provided by a mobile device may make the device more valuable to the user.

### SUMMARY OF THE INVENTION

A device having a data capture arrangement to capture data included in a data identifier, the data identifier being separate from the device and a processor to receive the data and perform an operation, the processor using at least a portion of the data to perform the operation.

A method for capturing data from a data identifier and performing an operation, the operation using at least a portion of the captured data.

### BRIEF DESCRIPTION OF THE DRAWINGS

FIG. 1 shows an exemplary embodiment of a system according to the present invention.

FIG. 2 shows an exemplary embodiment of a method according to the present invention.

FIG. 3 shows another exemplary embodiment of a system according to the present invention.

FIG. 4 shows another exemplary embodiment of a method according to the present invention.

### DETAILED DESCRIPTION

The present invention may be further understood with reference to the following description and the appended drawings, wherein like elements are referred to with the same reference numerals. The exemplary embodiments of the present invention generally relate to systems and methods for providing data to a mobile device. The data may be provided to the device as a result of a data request regarding a particular item. The data obtained may be used immediately or may be stored for a later purpose, or both. Although the exemplary embodiments will be described with respect to automatic phone number dialing, those skilled in the art will understand that the present invention may be applied to any functionality that may be desired by the user of a mobile device, e.g., pre-filling email fields, launching applications, accessing web pages, etc.

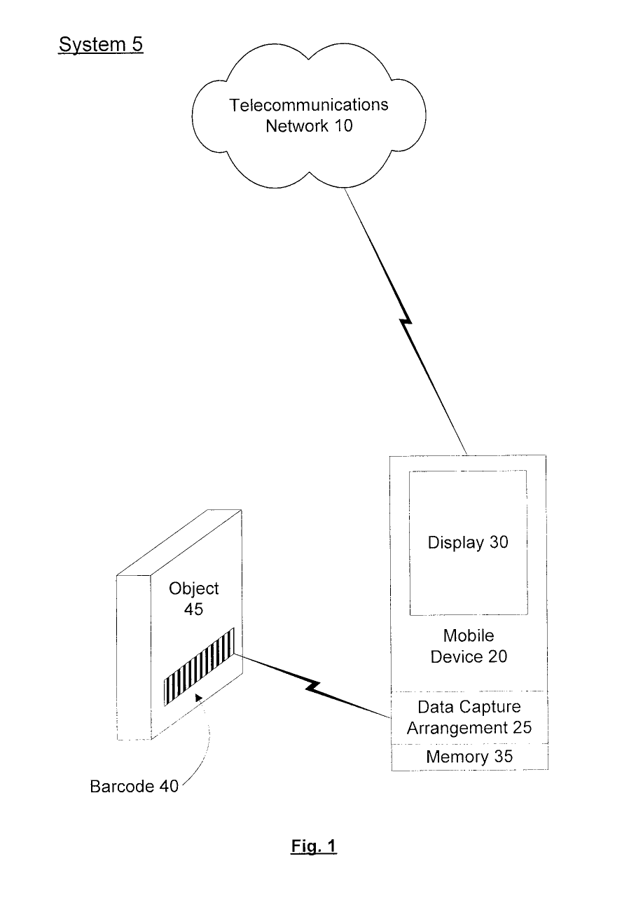

FIG. 1 shows an exemplary embodiment of a system 5 according to the present invention. The system 5 may include a communications network 10 (e.g., a wireless telephone network, a WLAN, etc.), which is accessible by a mobile device 20. The mobile device 20 may be any portable electronic device including, but not limited to, a mobile phone, a laser/image-based scanner, an RFID reader/tag, a PDA, a tablet computer, etc. The mobile device 20 may include a data capture arrangement 25, which may be, but is not limited to, a laser- and/or imager-based scanner, a digital camera, or an RFID reader. The mobile device 20 may also include a display (e.g., an LCD) 30 and a memory 35. The mobile device 20 may also include additional hardware (e.g., a processor) and software (e.g., applications) to provide the user with various types of functionality. For example, as will be described in more detail below, the mobile device 20 may include hardware and/or software for providing phone functionality to the user (e.g., VoIP, CDMA, GSM, etc.).

A user may utilize the mobile device 20 to obtain data from a target object. For example, the mobile device 20 may scan a barcode 40 on an object 45 to obtain barcode data. In this exemplary embodiment, the barcode 40 is included as part of a contact list object 45. Thus, the data included in the barcode 40 may include name data, title data, company data, address data, phone number data, fax number data, email address data, web page data, etc., for individuals and/or entities on the contact list. Thus, when the mobile device 20 reads the barcode 40, the data associated with the corresponding entry in the contact list will be transferred to the mobile device 20. The mobile device 20 may then, for example, display the information from the barcode 40 on the display 30, automatically dial the phone number included with the data, and store the information obtained in memory 35. Thus, by merely scanning the barcode 40, different functions of the mobile device 20 may be implemented.

According to the exemplary embodiment of the present invention, the barcode 40 may be located on various objects 45. Object 45 may be, but is not limited to, a contact list, an address book, a business card, a letter, a document containing information or advertising about a product, or a computer screen displaying the barcode 40. In another exemplary use, the barcode 40 may be placed on a product or a product display by a manufacturer.

Those skilled in the art will understand that the data to be captured is not limited to being stored in barcodes, but may be stored in any other type of data identifier. For example, the data capture arrangement 25 may include an RFID reader. In such a case, the object 45 may include an RFID tag that includes the data which is to be collected by the mobile device 20. Alternately, data capture arrangement 25 may include an image-based scanner. In this case, the object 45 may include a non-barcode picture as a data identifier which includes the data which is to be collected by the mobile device 20.

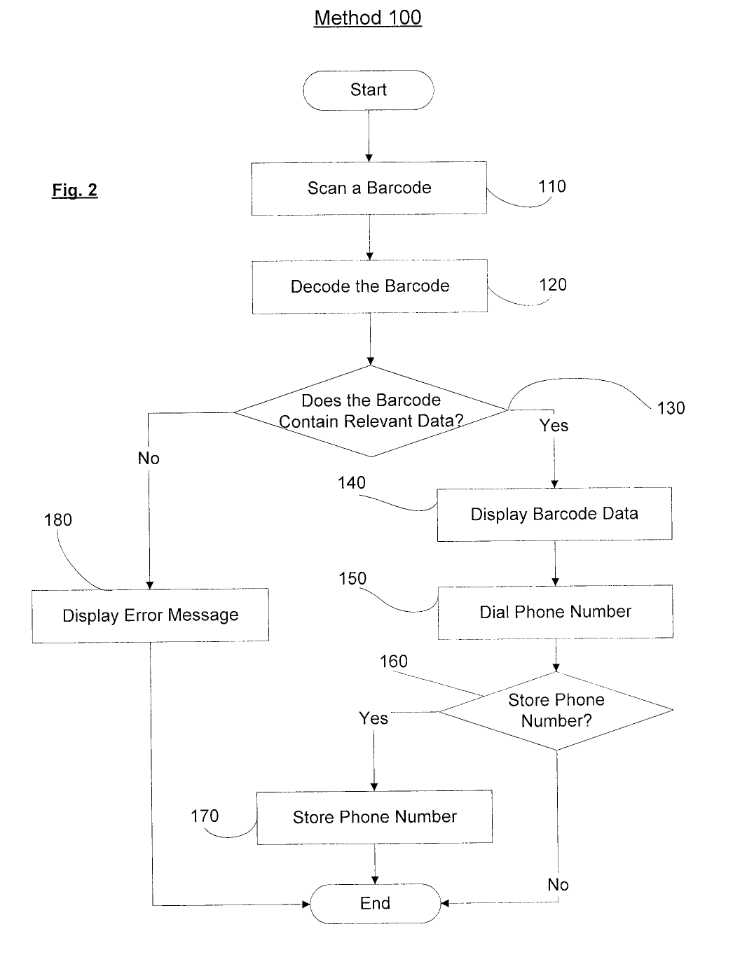

FIG. 2 shows an exemplary embodiment of a method 100 for providing data to a mobile device according to the present invention. The method 100 will be described with reference to the system 5 of FIG. 1. In step 110, the mobile device 20 scans a barcode. In step 120, the mobile device decodes the barcode. In step 130, it is determined what type or types of data the barcode contains. In the context of step 130, relevant data may include any data that is readable and decodable by the mobile device 20. Thus, if the mobile device cannot read or decode the data included in the barcode 40, the data is not relevant. Relevant data may also refer to the functionality that corresponds to the data in the barcode. For example, if the barcode 40 includes phone number data, but the mobile device 20 does not include phone functionality, the data is not relevant to the mobile device 20. Thus, the determination of relevance of the data may include a variety of factors. If no relevant data was found in step 130, the method proceeds to step 180, where an error message is displayed by the device, and the method 100 ends. The error message may be, for example, “data not readable,” “unsupported function,” etc.

It should be noted that the barcode 40 (or other data object) may include data as described above, but it may also include executable code or other codes for launching an application. For example, the barcode 40 may include the phone number as described above, but it may also include executable code (e.g., an applet) that indicates to the phone application in the mobile device 20 that the phone number included in the scanned barcode 40 should be dialed. In an alternative exemplary embodiment, the barcode 40 may include a code such as a binary number, etc., that indicates to the phone application that the corresponding number should be dialed (e.g., when the phone application receives a number along with a specified code, the phone application automatically dials the number). In a further exemplary embodiment, the phone application may be programmed to automatically dial the phone number whenever it is received or to provide a prompt to the user when it is received. Thus, the functionality of the mobile device 20 that is triggered when the barcode 40 is read may be based on the information included in the barcode 40 itself, or in combination with information included in the application on the mobile device 20.

If the barcode contains relevant data, the method proceeds to step 140, where a telephone number included in the barcode data is displayed by the mobile device 20. In step 150, the telephone number is dialed by the mobile device 20. In step 160, the user is given a choice whether to store the telephone number and other data contained by the barcode 40. If the user elects to do so, in step 170 the data is stored in a memory 35 of the mobile device 20. Following step 160 or step 170, the method 100 ends.

Those skilled in the art will understand that automatically dialing a phone number is only exemplary. Other exemplary functions may include, for example, automatically sending an email. In such an example, a product display may include a barcode and the scanning of the barcode may cause an email application of the mobile device 20 to open a new email, pre-fill the “To:” field and the “Subject” field or “Body” field for the user to request the specifications of the product being displayed. In another embodiment, the scanning of the barcode 40 may cause a URL to be inserted into a web browser application of the mobile device 20, such that a corresponding web page is displayed to the user.

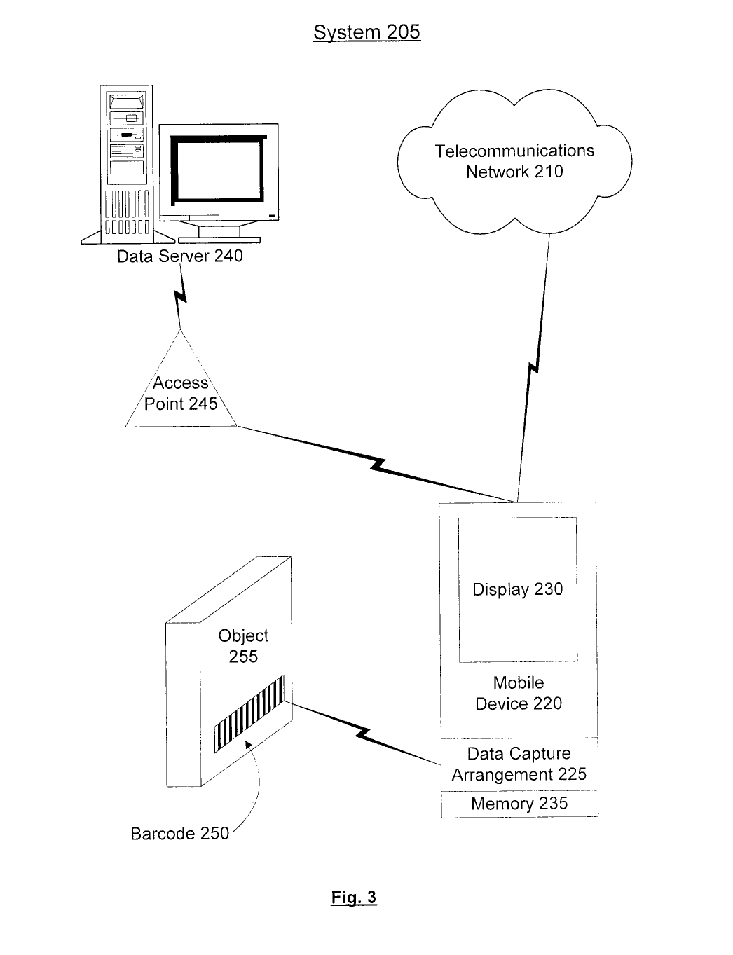

FIG. 3 shows another exemplary embodiment of a system 205 according to the present invention. The system 205 may include a communications network 210 (e.g., a wireless telephone network, a WLAN, etc.), which is accessible by a mobile device 220. The mobile device 220 may be any portable electronic device including, but not limited to, a mobile phone, a laser/image-based scanner, an RFID reader/tag, a PDA and a tablet. The mobile device 220 may include a data capture arrangement 225, which may be, but is not limited to, a laser- and/or imager-based scanner, a digital camera, or an RFID reader. The mobile device 220 may also include a display (e.g., an LCD) 230 and a memory 235. The system 205 may also include a data server 240 which is accessible by the mobile device 220 via access point 245.

A user may utilize the mobile device 220 to obtain data from a target object. For example, the mobile device 220 may scan a barcode 250 on an object 255 to obtain barcode data. The mobile device may transmit the barcode data to a data server 240 via the access point 245. The data server 240 may determine whether it contains any data about the barcode 250. The barcode data may contain information about an entry on the contact list 45 (e.g., a telephone number or an address). The data server may transmit any such data back to the mobile device 220 via the access point 245, or if no data is found, may transmit an error message reflecting this fact. The mobile device 220 may then display transmitted information on the display 230, automatically dial the phone number by accessing communications network 210, and store the information obtained in memory 235. As stated above for the exemplary embodiment presented in FIG. 1, those of skill in the art will understand that the phone dialing process described here is only exemplary, and that other functions, such as sending an email or accessing a web page, may be accomplished using the same concepts. Further, while the exemplary embodiment described above describes communication between the mobile device 220 and the data server 240, those of skill in the art will understand that the data server 240 may be replaced by any object located external to the mobile device 220.

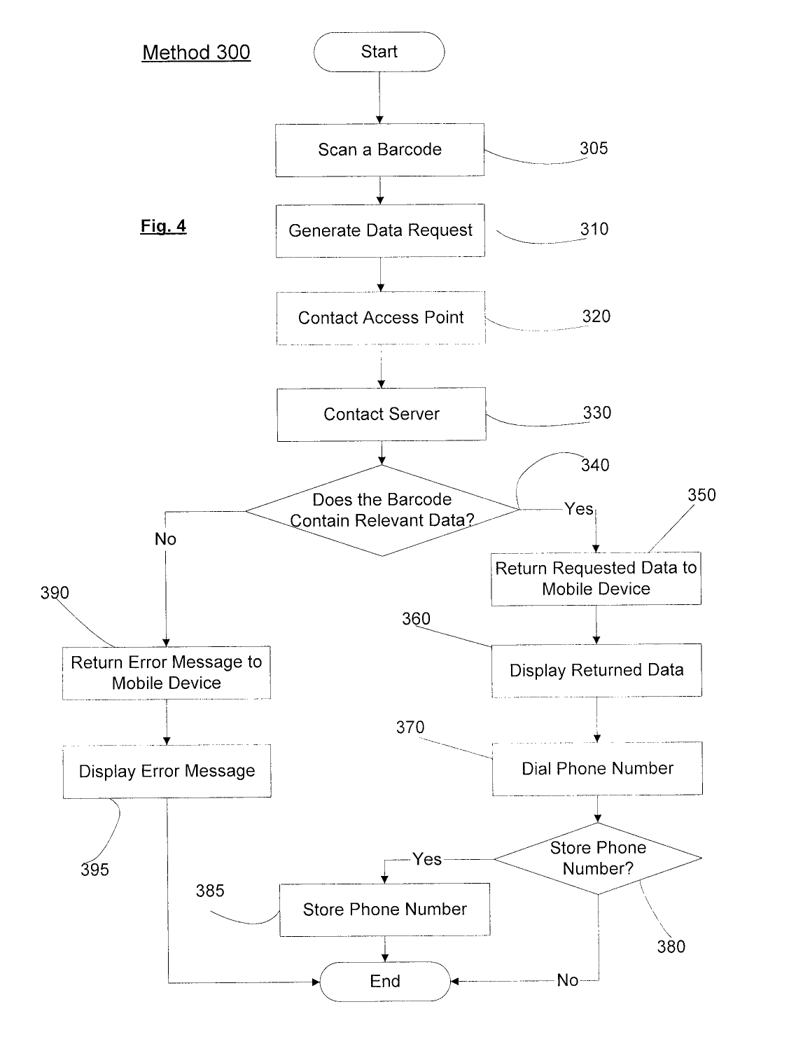

FIG. 4 shows an exemplary embodiment of a method 300 for providing data to a wireless device according to the present invention. The method 300 will be described with reference to the system 205 of FIG. 3. In step 305, the mobile device 220 scans a barcode using data capture arrangement 225. In step 310, the mobile device generates a data request including barcode data from the barcode scan in step 301. In step 320, the mobile device 220 contacts the access point 245. To do this, the mobile device 220 and the access point 245 may utilize a predetermined wireless communications protocol (e.g., IEEE 802.1x protocol) for conducting wireless communications. In step 330, the data request generated in step 310 is transmitted to the server 240 via access point 245.

In step 340, the data server 240 determines whether the barcode data corresponds to a data record stored on the data server 240. As described above, the data to be searched for may be, but is not limited to, a telephone number or an address. If a corresponding data record is found, the method proceeds to step 350. If no corresponding data record is found, the method proceeds to step 390. In step 390, the data server 240 returns an error message to mobile device 220 via access point 245. In step 395, the mobile device 220 displays the error message to the user through the use of display 230, and the method 300 ends. The error message displayed in step 395 may be, but is not limited to, one of the messages described above in step 180 of method 100.

In step 350 the data is returned to mobile device 220. In step 360, the mobile device 220 displays the resulting data using display 230. In step 370, the mobile device 220 dials a telephone number corresponding to the barcode 250 using telecommunications network 210. In step 380, the user is given the option to store a telephone number corresponding to barcode 250. If the user elects to do so, the method proceeds to step 385. If the user elects not to do so, the method 300 is complete. In step 385, the mobile device 220 stores the phone number in memory 235. Following step 385, the method 300 is complete. As described above for method 100, the principles described for this exemplary embodiment may be employed to provide other functionalities to the user, including, but not limited to, sending an email or accessing a web page.

It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

1. A device, comprising:
a data capture arrangement capturing data included in a data identifier, the data identifier being separate from the device; and
a processor receiving the data and performing an operation indicated by the data, the operation using at least a portion of the data.

2. The device of claim 1, further comprising: a transmitter, wherein the operation includes the transmitter transmitting one of the portion of the data and a representation of the portion of the data.

3. The device of claim 2, further comprising: a receiver receiving further data, wherein the processor performs the operation using the further data.

4. The device of claim 1, wherein the data capture arrangement includes at least one of a barcode reader, an image-based scanner, a laser-based scanner, and an RFID reader.

5. The device of claim 1, wherein the data identifier includes at least one of a barcode, an RFID tag, and a non-barcode picture.

6. The device of claim 1, wherein the portion of the data includes at least one of a telephone number, an email address, and a web page address.

7. The device of claim 1, wherein the device includes at least one of a mobile telephone, a PDA, a portable computer, and a barcode reader.

8. The device of claim 1, wherein the data identifier is included in an object, the object being one of a contact list, a business card, a product display; a computer display, and a product catalog.

9. The device of claim 2, wherein the transmitter transmits the portion of the data via one of a telecommunications network and a WLAN.

10. A method, comprising:
capturing data from a data identifier; and
performing an operation, the operation being indicated by the data, the operation using at least a portion of the captured data.

11. The method of claim 10, wherein the performing step includes:
transmitting one of the portion of the data and a representation of the portion of the data.

12. The method of claim 11, further comprising:
receiving return data as a function of the transmitting step.

13. The method of claim 10, wherein the data is captured by at least one of a barcode reader, an image-based scanner, a laser-based scanner, and an RFID reader.

14. The method of claim 10, wherein the data identifier is at least one of a barcode, an RFID tag, and a non-barcode picture.

15. The method of claim 10, wherein the data identifier is included in an object, the object being one of a contact list, a business card, a product display, a computer display, and a product catalog.

16. The method of claim 10, wherein the portion of the data is at least one of a telephone number, an email address, or a web page address.

17. The method of claim 10, wherein the operation is performed by one of a mobile telephone, a PDA, a portable computer, and a barcode reader.

18. The method of claim 11, wherein the transmission is via one of a telecommunications network and a WLAN.

19. A device, comprising:
first means for capturing data from an object, the object being separate from the first means;
second means for receiving the captured data and performing an operation indicated by the captured data, the second means using at least a portion of the captured data to perform the operation; and
third means for transmitting one of the portion of the captured data and a representation of the portion of the captured data.
